(19) United States
(12) Patent Application Publication
(10) Pub. No.: US 2009/0227303 A1
(43) Pub. Date: Sep. 10, 2009

(54) GAMING MACHINE ENABLING TO ARBITRARILY SELECT AND OUTPUT A PLURALITY OF SOUND DATA FOR PLAYING IN A RACE IN WHICH A PLURALITY OF CHARACTER RACE, AND A GAMING SYSTEM

(75) Inventor: Fumiya ABE, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/235,048

(22) Filed: Sep. 22, 2008

Related U.S. Application Data
(60) Provisional application No. 61/034,282, filed on Mar. 6, 2008.

(51) Int. Cl. G06F 17/00

(52) U.S. Cl. 463/6; 463/16; 463/31; 463/35; 463/40

(57) ABSTRACT

In a racing game, a controller 202 selects a predetermined sound data from a plurality of sound data, in accordance with the bet amount made before executing a race, and then outputs the sound data from speakers 50. Different sound data are provided for different bet amounts. The sound data includes race sound for enlivening the racing game and sound effects that can be arbitrarily output by players. Sound effects are output in response to an operation of a sound effect output switch 60.

### CROSS REFERENCE TO RELATED APPLICATIONS

This application claims benefit of U.S. Provisional Application No. 61/034,282, filed Mar. 6, 2008, the entire contents of which are incorporated herein by reference.

### BACKGROUND OF THE INVENTION

1. Field of the Invention

The present invention relates to a gaming machine enabling arbitrary selection and output of a plurality of sound data for playing in a race in which a plurality of characters race, and a gaming system.

2. Related Art

Conventionally, racing games in which a plurality of characters races, a player bets by predicting the order of finishing, and the player is awarded based on the rank of the bet character and an odds announced before the start of the race, are known. A representative example of the racing game is a horse racing game. A representative example of the racing character is a horse; however, the character can be a car, other animals, and the like. A player bets by predicting a character finishing first or a finishing order of characters in a race.

Various effects are provided so as to make the race exciting. For example, U.S. Pat. No. 5,320,351 discloses a racing game, in which model horses with jockeys run in a field that represents a real race course, thereby recreating an actual race. Additionally, a racing game in which a horse race animation is played back on a large display is disclosed, as described in U.S. Pat. No. 6,848,991.

Generally, the effects include, in addition to the abovementioned visual effects, music and sound effects to generate a synergistic effect that makes a race exciting. However, similar sound effects are provided in the same situations in a race, and may become routine after a plurality of races. This may also make the racing game routine and thus cause the players to lose interest.

The present invention is made in view of the abovementioned problems, and the objective thereof is to provide a gaming machine and a gaming system enabling arbitrary selection and output of a plurality of pieces of sound data for playing in a race, and to avoid routine effects therein.

### SUMMARY OF THE INVENTION

In a first aspect of the present invention, a gaming machine includes: a display for displaying images relating to a racing game in which a plurality of characters race; memory for storing a plurality of pieces of sound data; speakers for outputting the sound data; and an operation device for performing a bet operation on the characters that race; and a controller for executing steps of: (a) selecting sound data from the plurality of pieces of sound data while the racing game is in operation; and (b) outputting the sound data from the speakers while the racing game is in execution.

According to the first aspect of the present invention, the gaming machine includes memory for storing a plurality of pieces of sound data, from which the controller selects and outputs a piece of sound data while the racing game is in execution. In other words, different sound data is output in each racing game.

In a second aspect of the present invention, a gaming machine includes: a display for displaying images relating to a racing game in which a plurality of characters race; first memory for storing a plurality of pieces of sound data associated to a bet amount; speakers for outputting the sound data; and a bet operation device for accepting a bet operation on the characters that race; second memory for storing the bet amount; and a controller for executing steps of: (a) storing the bet amount to the second memory when a bet is made; (b) selecting sound data associated to the bet amount stored in the second memory; and (c) outputting the sound data selected from the speakers while the racing game is in execution.

According to the second aspect of the present invention, a plurality of pieces of sound data associated with bet amounts are stored in memory, and a piece of sound data is selected therefrom and output according to a bet amount made by a player.

In a third aspect of the present invention, the gaming machine described in the second aspect further includes: a sound output operation device for generating an output signal for outputting sound from the speakers in response to an operation by a player, in which the controller further executes a step of: (d) outputting the sound data selected from the speakers in response to an operation of the sound output operation device.

According to the third aspect of the present invention, the gaming machine of the second aspect further includes a sound output operation device for generating an output signal for outputting sound from the speakers in response to an operation by a player. Sound data is output in response to an output signal generated by an operation of the sound output operation device.

According to a fourth aspect of the present invention, in the gaming machine as described in the second aspect, the speakers are directional speakers outputting sound to a predetermined direction.

In a fifth aspect of the present invention, a gaming system includes: a plurality of terminals having a bet operation device for accepting a bet operation for the characters that race in the racing game in which a plurality of characters race; a display for displaying images relating to the racing game, installed in a position visually recognizable by each of users operating the plurality of terminals; first memory for storing a sound selection table in which a plurality of pieces of sound data are associated with a total bet amount; second memory for storing the total bet amount of a bet made on each of the plurality of terminals; speakers for outputting the sound data; and a controller for controlling the entire of the game, having a communication device for communicating with the plurality of terminals, in which the controller executes processing of: (a) receiving the bet amount from each of the plurality of terminals; (b) accumulating the bet amount received from each of the plurality of terminals, and storing a result thereof in the second memory; (c) selecting a piece of sound data from the plurality of pieces of the sound data, based on the total bet amount and the sound selection table stored in the first memory; and (d) outputting the piece of sound data from the speakers while the racing game is in execution.

According to the fifth aspect of the present invention, a plurality of pieces of sound data associated with bet amounts is stored in memory. The controller selects a piece of sound data from the plurality of pieces of sound data, according to the sum of bet amounts received from the plurality of terminals. Then, the controller outputs the selected piece of sound data.

In a sixth aspect of the present invention, a gaming system includes: a plurality of terminals having a communication method for connecting and communicating with a network; a center controller for controlling the entire of the game, having a communication device for communicating with the plurality of terminals; a display for displaying images relating to the racing game, installed in a position visually recognizable by each of users operating the plurality of terminals; first memory for storing a sound selection table in which information pieces representing a plurality of pieces of sound data are associated with a total bet amount; and second memory for storing the total bet amount of a bet made on each of the plurality of terminals; in which each of the plurality of terminals includes: local memory for storing the plurality of pieces of sound data; speakers for outputting the sound data; and a bet operation device for accepting, in the racing game in which a plurality of characters race, a bet operation on the characters; a sound output operation device for generating an output signal for outputting sound in response to an operation by a player; and a local controller for outputting the sound data selected from the plurality of pieces of sound data by the center controller from the speakers, in which the center controller at least executes steps of: (A) receiving a bet amount from each of the plurality of terminals; (B) accumulating the bet amount received from the plurality of terminals and storing a result thereof in the second memory; (C) based on the total bet amount stored in the second memory, selecting an information piece representing a piece of sound data from the information pieces representing the plurality of pieces of sound data stored in the first memory; and (D) transmitting the information piece representing the piece of sound data to the plurality of terminals, so as to output the sound data from the speakers, in which the local controller executes steps of: (a) upon receiving the information representing the piece of sound data, selecting a piece of sound data corresponding to the information piece representing the piece of sound data; and (b) outputting the sound data from the speakers in response to the output signal generated by the sound output operation device.

According to the sixth aspect of the present invention, a plurality of pieces of sound data associated with bet amounts is stored in memory. The controller selects a piece of sound data from the plurality of pieces of sound data, according to the sum of bet amounts received from the plurality of terminals. Then, the sound output operation device is operated in the plurality of terminals, and, in response to an output signal generated thereby, a piece of sound data corresponding to an information piece representing thereof received from the center controller is output from the speakers in each of the plurality of terminals.

According to a seventh aspect of the present invention, in the gaming system as described in the sixth aspect, the speakers are directional speakers outputting sound to a predetermined direction.

### BRIEF DESCRIPTION OF THE DRAWINGS

FIG. 1 is a flow chart showing the main part of the present invention;

FIG. 2 is a perspective view illustrating the appearance of the terminal device according to a preferred embodiment of the present invention;

FIG. 3 is a top view illustrating the appearance of the terminal device according to the preferred embodiment of the present invention;

FIG. 4 is a block diagram illustrating the terminal device according to the preferred embodiment of the present invention;

FIG. 5 is a flow chart showing a flow of the terminal device according to the preferred embodiment of the present invention;

FIG. 6 is a diagram showing a sound selection table according to the preferred embodiment of the present invention;

FIG. 7 is a perspective view showing the gaming system according to the preferred embodiment of the present invention;

FIG. 8 is a diagram showing the configuration of a gaming system according to the preferred embodiment of the present invention;

FIG. 9 is a block diagram of a main controller of the gaming system according to the preferred embodiment of the present invention;

FIG. 10 is a diagram showing the main flow chart of a gaming system according to the preferred embodiment of the present invention; and

FIG. 11 is a flowchart showing sound selection processing in FIG. 10.

### DETAILED DESCRIPTION OF THE INVENTION

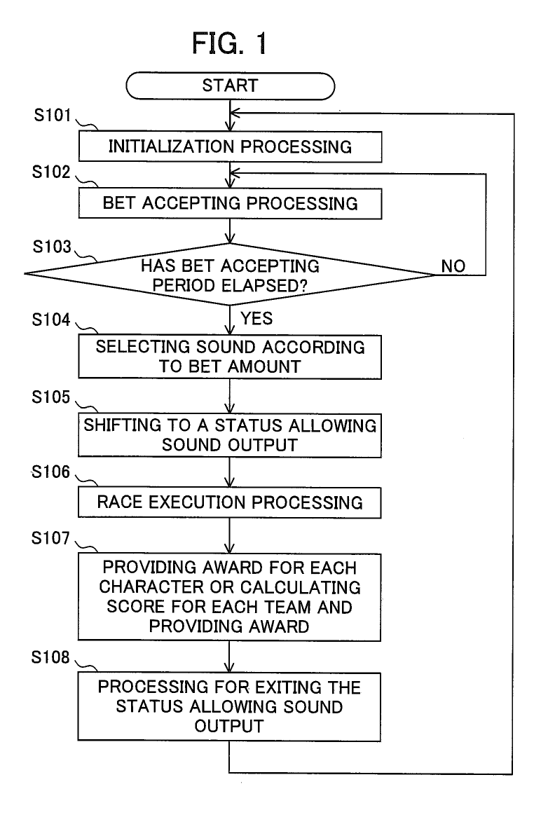

The main part of the present invention is described hereinafter with reference to FIG. 1. The sub control unit 202 of the terminal device 30, which is a gaming machine according to the present invention, performs initialization processing (Step S101), and then advances to Step S102. In the initialization processing, characters participating in the race, a course for a race, and the like are determined. In Step S102, the sub control unit 202 accepts a bet before executing a racing game, and then advances to Step S103. In Step S103, the sub control unit 202 determines whether a bet accepting period has elapsed or not. In the case of a YES determination, processing is advanced to Step S104, and in the case of a NO determination, processing is advanced to Step S102. In Step S104, the sub control unit 202 selects a sound to be output during a race based on the bet amount, and then advances to Step S105. In Step S105, the status of the sub control unit 202 is shifted to a status allowing sound output, and then proceeds to Step S106. In this processing, the sound selected in Step S104 is read from ROM 233 and made ready for output anytime in response to an operation of a sound effect output switch 60. In Step S106, a racing game is executed, and then processing is advanced to Step S107. In Step S107, the sub control unit 202 determines a payout based on a result of the race, and provides an award. In Step S108, the sub control unit 202 exits from the status allowing sound output.

### First embodiment

A first embodiment of the present invention is described hereinafter.

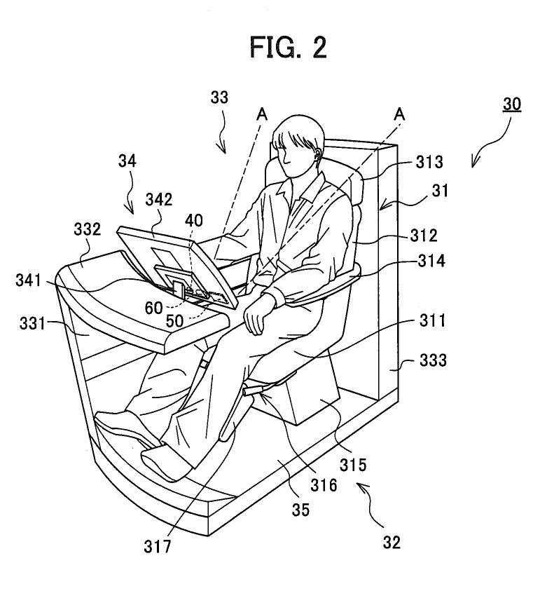

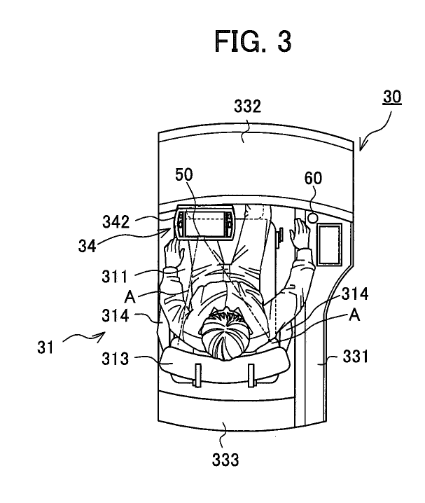

A terminal device 30 is described with reference to FIGS. 2 and 3. FIG. 2 is a perspective view showing an appearance of the terminal device 30. FIG. 3 is a top view showing an appearance of the terminal device 30.

The terminal device 30 includes: a seat 31 on which a player can sit; an opening 32 formed on one of four lateral faces of the terminal device 30; a seat encircling portion 33 that covers three of four lateral faces of the terminal device 30 except for the lateral face having the opening 32; and a sub display device 34 installed on the seat encircling portion 33, in a front portion of the terminal device 30, that displays images related to the game. In addition, speakers 50 are provided in the sub display device 34.

The seat 31 includes: a seating surface 311 on which a player sits; a backrest 312 supporting the back of a player; a headrest 313 installed on top of the backrest 312; armrests 314 installed on both sides of the backrest 312; and a leg portion 315 fixed to the base portion 35.

The seat encircling portion 33 includes: a side unit 331 installed on an opposite face to the lateral face having the opening 32; a front unit 332 installed in the front portion of the terminal device 30; and a back unit 333 installed in the rear portion of the terminal device 30. This allows a player to sit on and get out of the seat 31 through the opening 32, at which the seat encircling portion 33 is not formed.

A medal slot to which medals corresponding to credits are inserted, a medal payout opening that pays out medals corresponding to credits, and the like are disposed on the side unit 331 (not shown). It should be noted that the gaming medium used in the present embodiment is medals; however, the present invention is not limited thereto. Examples of the gaming medium include coins, tokens, electronic money, or any equivalent valuable information such as electronic credit. In this case, credits can be paid out by a ticket printed out from a ticket printer 216 (described later). In addition, a sound effect output switch 60 is provided in the side unit 331. The sound effect output switch 60 is pushed by a player to output other sound effects than a sound effect output in the game.

The front unit 332 is a table having the base portion 35 and a substantially horizontal top board, which is movably supported on the side unit 331, in the front portion of the terminal device 30. A player sitting on the seat 31 can put their legs into a space under the front unit 332.

The back unit 333 is integrated with the side unit 331 and constitutes a portion of the seat encircling portion 33.

The sub display device 34 includes a supporting arm 341 supported by the front unit 332 and a rectangular liquid crystal monitor 342 for displaying, fixed at the distal end of the supporting arm 341. The liquid crystal monitor 342 is a so-called touch panel, and is provided at a position facing the chest of a player sitting on the seat 31. The liquid crystal monitor 342, which is a touch panel, serves as an input device used by a player to bet.

In addition, the speakers 50 are provided in the sub display device 34. The speakers 50 output sound effects in the terminal device 30. In addition, the speakers 50 are preferably so-called directional speakers. In other words, the speakers 50 output sound waves having directionality to a predetermined direction as the sound effect. Therefore, sound output from the speakers 50 has a reachable area shown as the dotted lines A in FIGS. 2 and 3. The directionality of the speakers 50 is configured so that the reachable area of sound includes the player. This allows a focused output of sound effects and the like to the player operating the terminal device 30. In addition, since the sound output from the speakers 50 of the terminal device 30 has directionality, it is not easily perceivable from players operating other terminal devices 30. This allows the player to feel free to output the sound effect using the sound effect output switch 60.

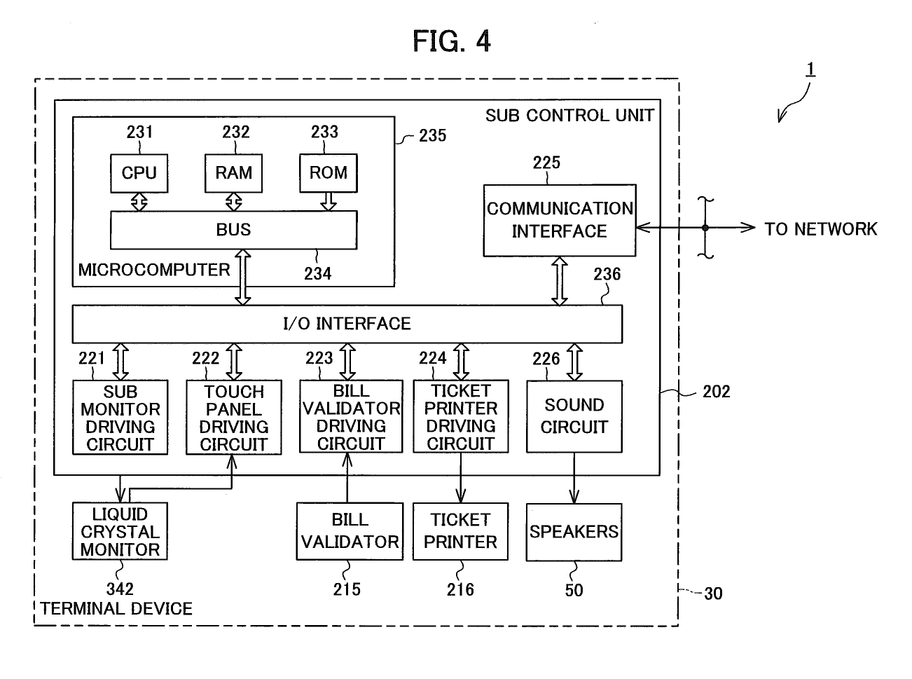

FIG. 4 is a block diagram showing the configuration of a sub control unit 202 as the controller included in the terminal device 30. The sub control unit 202 controls the terminal device 30 and basically is constituted mainly of a microcomputer 235 constituted of a CPU 231, RAM 232, ROM 233, and a bus 234 for data transfer therebetween. The RAM 232 and the ROM 233 are connected to the CPU 231 via the bus 234. The RAM 232 is memory for temporarily storing various data computed by the CPU 231. The ROM 233 stores various programs, data tables, and the like for processing required for the control of the terminal device 30.

A sub monitor driving circuit 221 is connected to the microcomputer 235 via the I/O interface 236. A liquid crystal monitor 342 is connected to the sub monitor driving circuit 221. The sub monitor driving circuit 221 controls the operation of the liquid crystal monitor 342 based on a driving signal from the CPU 231.

A touch panel driving circuit 222 is connected to the microcomputer 235 via the I/O interface 146. A liquid crystal monitor 342, which is a touch panel, is connected to the touch panel driving circuit 222. An instruction, by a touching operation by a user, to the surface of the liquid crystal monitor 342 (touched position) is input to the CPU 231 based on a coordinate signal from the touch panel driving circuit 222.

A bill validator driving circuit 223 is connected to the microcomputer 235 via the I/O interface 236. A bill validator 215 is connected to the bill validator driving circuit 223. The bill validator 215 determines whether a bill or a bar coded ticket is valid or not. Upon reception of a valid bill, the bill validator 215 inputs the value thereof to the CPU 231 based upon the validating signal from the bill validator driving circuit 223. In addition, upon reception of a valid bar coded ticket, the bill validator 215 inputs the amount of credits and the like recorded therein to the CPU 231 based upon the validating signal from the bill validator driving circuit 223.

A sound circuit 226 is connected to the microcomputer 235 via the I/O interface 236. The speakers 50 are connected to the sound circuit 226. The speakers 50 output sound effects, voice effects and the like for the game, based on an output signal from the sound circuit 226.

A ticket printer driving circuit 224 is connected to the microcomputer 235 via the I/O interface 146. A ticket printer 216 is connected to the ticket printer driving circuit 224. With an output control by the ticket printer driving circuit 224 based on a driving signal output from the CPU 231, the ticket printer 216 prints a bar code on a ticket, in which data such as a credit amount stored in the RAM 232 are coded, and then prints out a bar coded ticket.

The terminal device 30 can include a communication interface 225. In other words, the communication interface 225 is connected to the microcomputer 235 via the I/O interface 236. A server for management of a game hall through a network, other terminal devices 39, and the like can be connected to the communication interface 225.

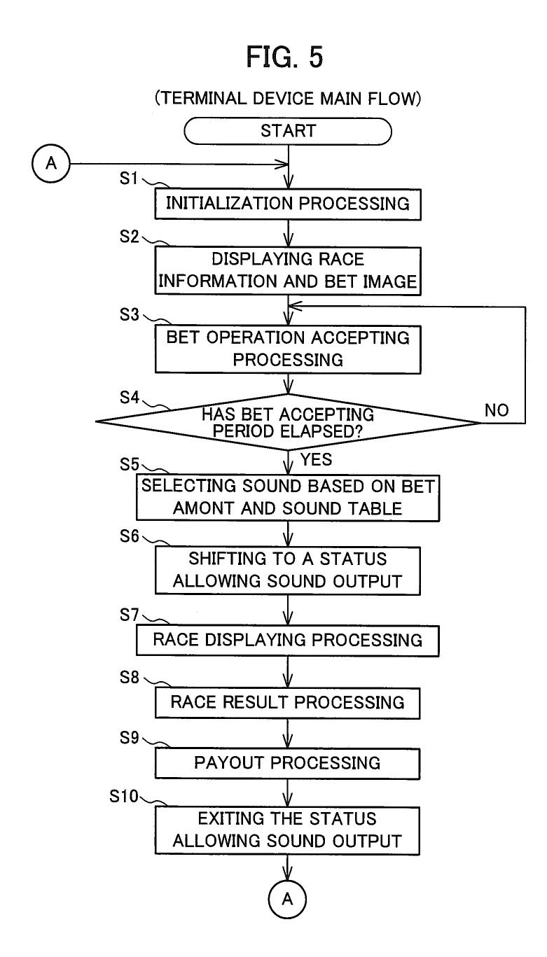

Flow of processing in the terminal device 30 is described with reference to FIG. 5.

Firstly, the sub control unit 202 performs initialization processing (Step S1), and then advances to Step S2. In the initialization processing, the CPU 231 determines a course of the race, characters participating the race, a starting time and the like of the horse racing game, and reads data thereof from the ROM 233.

In Step S2, the sub control unit 202 displays race information on the sub display device 34, and then advances to Step S3. In this processing, information such as the course of the race, the characters participating in the race and the like, determined in Step S1, are displayed on the sub display device 34(liquid crystal monitor 342).

In Step S3, the sub control unit 202 accepts a bet operation by a player, and then advances to Step S4. In this processing, the sub control unit 202 accepts a bet operation by a player via the liquid crystal monitor 342 as a touch panel, and stores the bet operation in the RAM 232.

In Step S4, the sub control unit 202 determines whether a time period for accepting has elapsed or not. In the case of a YES determination, processing is advanced to Step S5 and in the case of a NO determination, processing is advanced to Step S3.

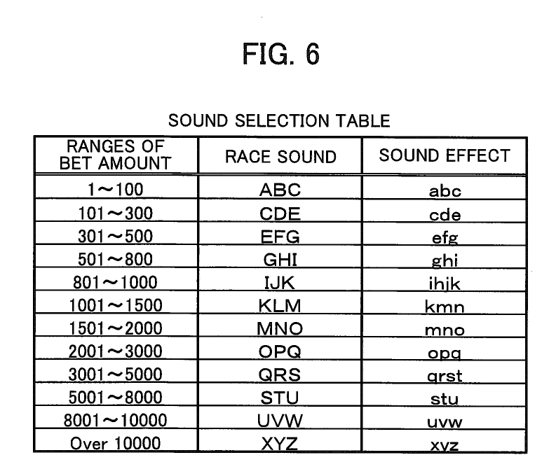

In Step S5, the sub control unit 202 selects a sound to be output during the race based on the bet amount and a sound selection table, which is later described in FIG. 6, and then advances to Step S6. In this processing, a different sound is selected to be output during the race, according to the bet amount specified in the bet operation by the player. In the present embodiment, in addition to the sound required for the race (such as fanfare to be output before the start of the race), sound effects to be output by a push operation of the sound effect output switch 60 is also selected in the step.

In Step S6, the status of the sub control unit 202 is shifted to a status allowing sound output, and then proceeds to Step S7. In this processing, the sub control unit 202 starts output of the sound determined in Step S5, and reads sound data, to be output by a push operation of the sound effect output switch 60, from ROM 233 and stores the sound data, in a stand-by state, in the RAM 232. The sound effect is output in response to an operation of the sound effect output switch 60.

In Step S7, the sub control unit 202 performs race display processing, and then advances to Step S8. In this processing, a race image is displayed on the sub display device 34 based on data what is read from the ROM 233 in Step S1, and outputs sound effects and voices from the speakers 50.

In Step S8, the sub control unit 202 performs race result processing, and then advances to Step S9. In this processing, the sub control unit 202 calculates a payout based on the race result and bets by players.

In Step S9, the sub control unit 202 performs payout processing, and then advances to Step S10. In this processing, the sub control unit 202 pays out the amount determined in Step S8.

In Step S10, the sub control unit 202 exits from the status allowing sound output, and advances to Step S1. The sub control unit 202 deletes the sound data read from the ROM 233 in the RAM 232.

The sound selection table is described with reference to FIG. 6. The sound selection table is used for selecting the sound to be output in accordance to a bet amount.

According to FIG. 6, ranges of a bet amount, pieces of race sound, and pieces of sound effects are associated to each other in the sound selection table. The ranges of a bet amount are used for selecting the sound. The race sound is output to make a race exciting, and the sound effect is output in response to an operation of the sound effect output switch 60 of the terminal device 30. Preferably, the greater the bet amount, the more boisterous the race sound and the sound effect become. In addition, the race sound and the sound effect can be different and may be a part of any musical composition or song, not limited to a short duration sound such as the sound of a bell, a trumpet, fanfare and the like.

To select a sound, the sub control unit 202 accepts a bet, determines the range of numerical values defined in the “ranges of a bet amount” column to which the bet amount belongs, and determines the race sound and the sound effect associated with the range (in the present embodiment, in the same row in the sound selection table).

For example, in a case where the amount of the bet made in the terminal device 30 is 150, the range to which the amount belongs is “101 to 300”. Consequently, the race sound “CDE” and the sound effect “cde” are selected.

### Second Embodiment

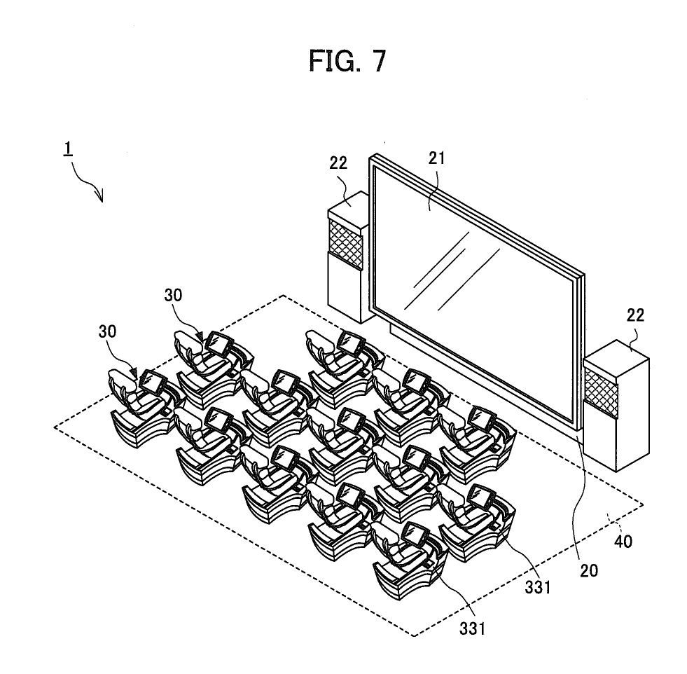

A second embodiment of the present invention is described hereinafter with reference to FIGS. 7 to 13. The second embodiment is different from the first embodiment in that a main controller 20, controlling a plurality of terminals, selects sound in the gaming system. It should be noted that differences from the first embodiment is mainly described. Accordingly, descriptions for the same components as those in the first embodiment are omitted. In the drawings, the same components as those in the first embodiment are referenced by the same reference numbers. It should be noted that the race execution is performed by the sub control unit 202 of the terminal device 30 in the first embodiment, and by the main control unit 112 of the main controller 20 in the second embodiment. The present embodiment is described in detail hereinafter.

FIG. 7 is a perspective view showing an appearance of a gaming system 1 including a plurality of terminal devices 30. The gaming system 1 is a multi-player gaming system for a multi-player-type horse racing game, in which a plurality of players can participate, including a plurality of terminal devices 30 and a main controller 20, which is a controller of the gaming system, having a large main display device 21.

The main controller 20 includes and controls the main display device 21 and a speaker device 22 installed on both sides of the main display device 21.

The main display device 21 is a large projector display device. The main display device 21 displays an image of a plurality of racehorses racing, a result of a race, and the like, in response to control by the main controller 20. On the other hand, a sub display device, which is included in each terminal device 30, displays odds information for each racehorse, information related to a bet made by the player themselves, and the like. It should be noted that a large projector display device is used in the present embodiment; however, the present invention is not limited thereto and any large monitor can be used.

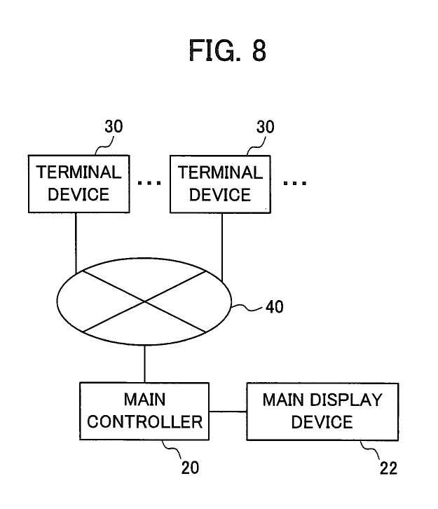

FIG. 8 is a schematic diagram showing a network of the gaming system 1.

In the gaming system 1, the main controller 20 and the plurality of terminal devices 30 can communicate with each other via a communication line and form a network 40. The main display device 21 is configured to be controlled from the main controller 20. The communication line can provide a wired or wireless connection.

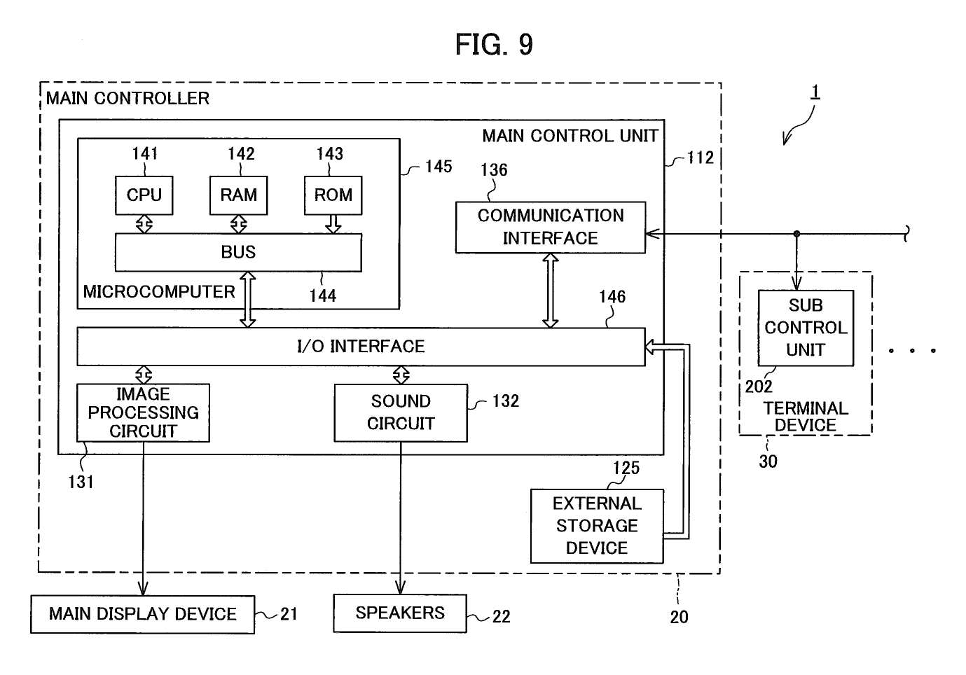

FIG. 9 is a block diagram showing the configuration of a main control unit 112 included in the main controller 20. Basically, the main control unit 112 is constituted mainly of a microcomputer 145 constituted of a CPU 141, RAM 142, ROM 143, and a bus 144 for data transfer therebetween. The RAM 142 and the ROM 143 are connected to the CPU 141 via the bus 144. The RAM 142 is memory for temporarily storing various data computed by the CPU 141. The ROM 143 stores various programs for processing required for the control of the gaming system 1, data tables, and the like.

An image processing circuit 131 is connected to the microcomputer 145 via an I/O interface 146. The image processing circuit 131 is connected to the main display device 21 and controls the operation thereof.

The image processing circuit 131 is constituted of: program ROM; image ROM; an image control CPU; work RAM; a video display processor (VDP); video RAM; and the like. The program ROM stores an image control program and various selection tables related to the display on the main display device 21. The image ROM stores pixel data for forming an image, such as pixel data for forming an image on the main display device 21. The image control CPU determines an image to be displayed on the main display device 21 from pixel data prestored in the image ROM based on a parameter defined by the microcomputer 145 and in accordance with an image control program prestored in the program ROM. The work RAM functions as a temporary storage device for executing the image control program by the image control CPU. The VDP generates image data according to the display content determined by the image control CPU, and outputs the same to the main display device 21. The video RAM functions as a temporary storage device to be used for forming an image by the VDP.

A sound circuit 132 is connected to the microcomputer 145 via the I/O interface 146. A speaker device 22 is connected to the sound circuit 132. The speaker device 22 generates various sound effects, BGM and the like for implementing various effects, based on a driving signal from the CPU 141 and with an output control by the sound circuit 132.

An external storage device 125 is connected to the microcomputer 145 via the I/O interface 146. The external storage device 125 operates similarly to the image ROM in the image processing circuit 131, in a case in which pixel data for forming an image, such as pixel data for forming an image on the main display device 21, is stored therein. Therefore, the image control CPU in the image processing circuit 131 selects an image to be displayed on the main display device 21 also from pixel data prestored in the external storage device 125.

A communication interface 136 is connected to the microcomputer 145 via the I/O interface 146. A sub control unit 202 of each terminal device 30 is connected to the communication interface 136. This allows for two-way communication between the CPU 141 and each terminal device 30. The CPU 141 transmits and receives instructions, requests, data and the like with respect to each terminal device 30 via the communication interface 136. Therefore, the main controller 20 of the gaming system 1 controls the progress of a horse racing game, in cooperation with each terminal device 30.

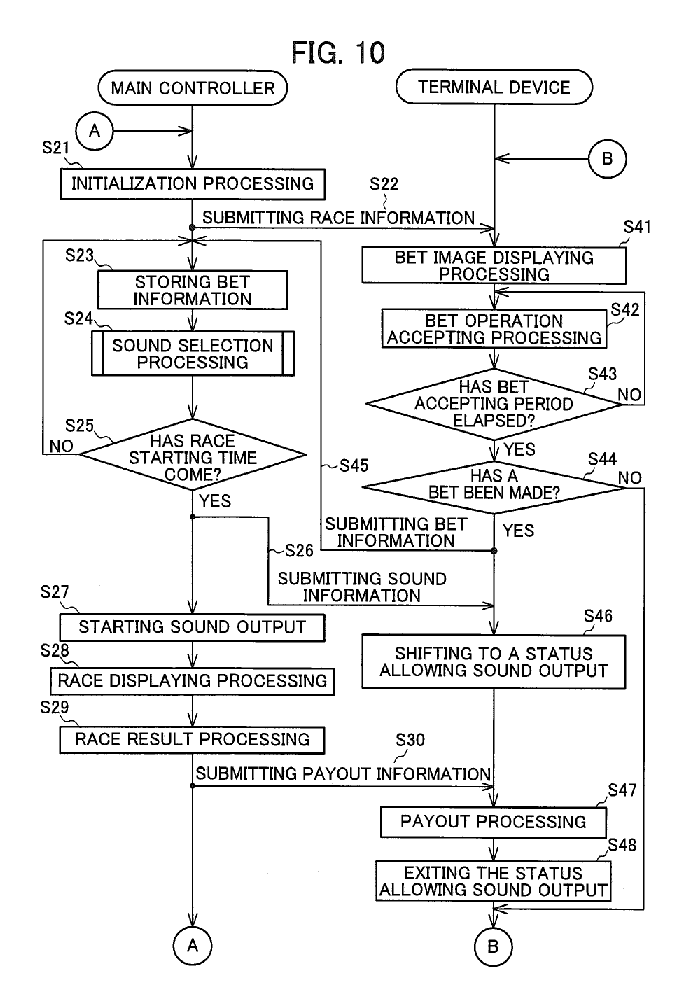

A flow of the operation of the gaming system 1 is explained hereinafter with reference to the flow chart shown in FIG. 10. It should be noted that all the terminal devices 30 similarly perform a game in cooperation with the main controller 20, although a single terminal device 30 is illustrated in FIG. 10.

The main controller 20 processes Step S21 to Step S30. Firstly, in Step S21, the main control unit 112 performs initialization processing, and then advances to Step S22. In this processing, the CPU 141 determines a course of the race, characters participating in the race, a starting time and the like of the horse racing game, and reads data thereof from the ROM 143.

In Step S22, the main control unit 112 transmits race information to each of the terminal devices 30, and then proceeds to Step S23. In this processing, the CPU 141 transmits a course of the race, characters participating in the race, a bet target team, a starting time and the like, to each terminal device 30.

In Step S23, the main control unit 112 stores the bet information, and then advances to Step S24. In this processing, the main control unit 112 stores the bet information received from the plurality of terminal devices 30 in the RAM 142 for each of the terminal devices 30.

In Step S24, the main control unit 112 performs sound selection processing, and then advances to Step S25. In this processing, the main control unit 112 selects a sound to be output during a race based on the total bet amount. This processing is later described in more detail.

In Step S25, the main control unit 112 determines whether it is the time for starting the race. In the case of a YES determination, processing is advanced to Step S26, and in the case of a NO determination, processing is advanced to Step S23. More specifically, the CPU 141 checks the clock time until the time for starting the race comes, and, at the time for starting the race, processing is advanced to Step S26.

In Step S26, the main control unit 112 transmits sound information to each terminal device 30, and then advances to Step S27. In Step S27, the main control unit 112 starts output of the sound selected in Step S24, and then advances to Step S27. The sound information is information regarding the sound determined in Step S24, which is output from the speakers 50 of the terminal device 30.

In Step S28, the main control unit 112 performs race displaying processing, and then advances to Step S29. In this processing, the CPU 141 displays a race image on the main display device 21 and outputs the race sound selected in Step S24, other sound effects, voices, and the like from the speaker device 22, based on data that is read from the ROM 143 in Step S1.

In Step S29, the main control unit 112 performs race result processing, and then advances to Step S30. In this process, the CPU 141 computes the payout for each terminal device 30 based on the order of arrival of characters that participated in the race, data regarding bet information received from each terminal device 30, and the like.

In Step S30, the main control unit 112 performs payout information transmission processing, and then advances to Step S1. In this processing, the CPU 141 transmits data regarding payout and the like, computed in Step S29, to the corresponding terminal device 30.

On the other hand, each terminal device 30 processes Steps S41 to S48. Firstly, in Step S41, the sub control unit 202 performs bet image display processing, and then advances to Step S42. In this processing, the CPU 231 displays the odds for each racehorse, past records thereof and the like on the liquid crystal monitor 342, based on the data sent from the main controller 20 in Step S22.

In Step S42, the sub control unit 202 performs bet operation accepting processing, and then advances to Step S43. In this processing, the CPU 231 enables touch operation by a player on the surface of the liquid crystal monitor 342, which is a touch panel, starts accepting bet operations by the player, and changes images displayed thereon in accordance with the bet operation.

In Step S43, the sub control unit 202 determines whether the predetermined period has elapsed or not, and then advances to Step S44. In the case of a YES determination, processing is advanced to Step S44, and in the case of a NO determination, advances to Step S42. More specifically, the CPU 231 repeatedly checks the clock time until a predetermined period has elapsed since the bet operation accepting processing is started in Step S42, and, once the predetermined period has elapsed, stops accepting bet operations by the player and advances to Step S44.

In Step S44, the sub control unit 202 determines whether a bet operation has been performed or not. In the case of a YES determination, processing is advanced to Step S45, and in the case of a NO determination, processing is advanced to Step S41. In this processing, the CPU 231 determines whether a bet operation has been performed in the abovementioned period in which the bet operation has been accepted.

In Step S45, the sub control unit 202 performs bet information transmission processing, and then advances to Step S46. In this processing, the CPU 231 transmits data regarding the performed bet operation to the main controller 20.

In Step S46, the status of the sub control unit 202 is shifted to a status allowing sound output, and then advances to Step S47. In this processing, the sub control unit 202 makes the sound ready for output from the speakers 50 of the terminal device 30 based on the sound information received from the main controller 20 in Step S27. More specifically, the sub control unit 202 reads the sound data from the ROM 233 based on a sound name included in the sound information, and stores the sound data in the RAM 232. The sound is made ready for output in response to an operation of the sound effect output switch 60. This allows a sound effect to be output when the sound effect output switch 60 is operated while the race is in operation (a period between a bet operation and payout processing), where the sound effect is selected in accordance with the total bet amount.

In Step S47, the sub control unit 202 performs payout processing, and then advances to Step S48. In this processing, the CPU 231 pays out medals from the medal payout opening, based on the data regarding payout and the like sent from the main controller 20 in Step S30.

In Step S48, the sub control unit 202 exits from the status allowing sound output and advances to Step S41. In this processing, the sub control unit 202 clears the sound in the RAM 232, which was ready for output in response to an operation of the sound effect output switch 60.

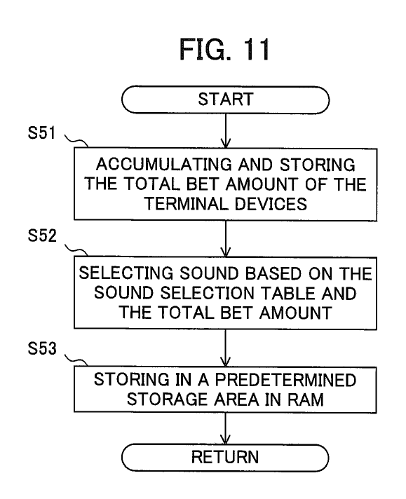

The sound selection processing is described with reference to FIG. 11.

In this processing, a sound is selected for output from the speakers 22 and each terminal device 30 during the race.

In Step S51, the main control unit 112 computes the total bet amount, and then advances to Step S52. In this processing, the main control unit 112 computes the sum total of bet amount received from each terminal device 30 and stored in the RAM 142, and stores the total bet amount in a predetermined storage region in the RAM 142.

In Step S52, the main control unit 112 selects a sound to be output from the speakers 22 and the speakers 50 of the terminal device 30 based on the total bet amount and a sound selection table, and then advances to Step S53. The sound table referenced by the main control unit 112 in Step S52 is similar to that of FIG. 6, and is stored in the ROM 143 of the main controller 20.

In Step S53, the main control unit 112 stores information regarding the sound selected in Step S52 to a predetermined storage region in the RAM 142, and then advances to Step S25 of FIG. 10.

According to the first embodiment, a gaming machine and a gaming system can be provided, which enable arbitrary selection and output of a plurality of pieces of sound data for playing in a race, to avoid a monotonous effects therein.

According to the first embodiment, the sub control unit 202 can select and output the sound to be output in the race, in response to an operation of the sound effect output switch 60. This allows players to freely output sound effects at arbitrary moments during the race, and can motivate the players to participate in the game. In addition, since the sound effect is selected in accordance with the total bet amount, a dashing sound effect can be associated with a higher bet amount to motivate the player participating in the game and to bring a sense of tension.

According to the first embodiment, speakers 50 are provided in the sub display device 34, where the speakers 50 are directional speakers. Furthermore, the speakers 50 are installed toward the player operating the terminal device 30. This can make the sound effect, which is output in response to an operation of the sound effect output switch, audible essentially only to the player operating the terminal device 30. This can prevent other players from knowing the amount the player has bet from the sound effect representation thereof, thus allowing the player to feel free to output the sound effect.

According to the second embodiment, the main controller 20 accumulates an amount of bets made on the plurality of terminal devices 30 and the main control unit 112 selects and outputs the sound corresponding to the sum total of the amount. For example, a resounding sound can be associated to a relatively high total bet amount, to announce a so-called big race with a big bet to the players. This can make the players more interested in the result of the game and bring a sense of tension, thus making the whole race more exciting.

In the above embodiments, all of the plurality of terminal devices 30 output the same sound in accordance to the bet amount; however, the present invention is not limited thereto. Each of the plurality of terminal devices can output different sounds. Since various kinds of sounds are output, the game hall can be made more exciting.

In the above embodiments, the speakers 50 of the terminal device 30 are directional speakers; however, the present invention is not limited thereto. For example, a switch can be provided for switching between directionality/non-directionality of the speakers, thus allowing players to arbitrarily select therefrom. The speakers thus can be directional for the players wishing not to make the sound perceivable from other players, and non-directional (as normal speakers) for players wishing to make the race more exciting.

According to the second embodiment, in the gaming system 1, the sound to be output from the speakers 50 of the terminal device 30 is determined by the sound information received from the main controller 20; however, the present invention is not limited thereto. For example, as in the first embodiment, the sound to be output can be determined in accordance with the bet amount of each of the terminal devices 30.

It should be noted that the gaming medium used in the present embodiment is medals; however, the present invention is not limited thereto. Examples of the gaming medium include coins, tokens, electronic money, or any equivalent valuable information such as electronic credit.

While the preferred embodiments of the present invention have been described above, it is apparent to one skilled in the art that various changes and modifications can be made without departing from the scope appended claims.

What is claimed is:

1. A gaming machine comprising:
a display for displaying images relating to a racing game in which a plurality of characters race;
memory for storing a plurality of pieces of sound data;
speakers for outputting the sound data; and
an operation device for accepting a bet operation on the characters that race; and
a controller for executing steps of:
(a) selecting a piece of sound data from the plurality of pieces of sound data while the racing game is executed; and
(b) outputting the piece of sound data from the speakers while the racing game is executed.

2. A gaming machine comprising:
a display for displaying images relating to a racing game in which a plurality of characters race;
first memory for storing a plurality of pieces of sound data associated to a bet amount;
speakers for outputting the sound data; and
a bet operation device for accepting a bet operation on the characters that race;
second memory for storing the bet amount; and
a controller for executing steps of:
(a) storing the bet amount in the second memory when a bet is made;
(b) selecting a piece of sound data associated to the bet amount stored in the second memory; and
(c) outputting the piece of sound data selected from the speakers while the racing game is executed.

3. The gaming machine according to claim 2, further comprising
a sound output operation device for generating an output signal for outputting sound from the speakers in response to an operation by a player,
wherein the controller further executes a step of:
(d) outputting the piece of sound data selected from the speakers in response to an operation of the sound output operation device.

4. The gaming machine according to claim 2,
wherein the speakers are directional speakers outputting sound in a predetermined direction.

5. A gaming system comprising:
a plurality of terminals having a bet operation device for accepting a bet operation for the characters that race in the racing game wherein a plurality of characters race;
a display for displaying images relating to the racing game, disposed at a position visually recognizable by each of users operating the plurality of terminals;
first memory for storing a sound selection table wherein a plurality of pieces of sound data are associated with a total bet amount;
second memory for storing the total bet amount of a bet made on each of the plurality of terminals;
speakers for outputting the sound data; and
a controller for controlling the entire of the game, having a communication device for communicating with the plurality of terminals,
wherein the controller executes processing of:
(a) receiving a bet amount from each of the plurality of terminals;
(b) accumulating the bet amount received from each of the plurality of terminals and storing a result thereof in the second memory;
(c) selecting a piece of sound data from the plurality of pieces of the sound data, based on the total bet amount and the sound selection table stored in the first memory; and
(d) outputting the piece of sound data from the speakers while the racing game is in operation.

6. A gaming system comprising: a plurality of terminals having a communication means for connecting and communicating with a network;
a center controller for controlling the entire of the game, having a communication device for communicating with the plurality of terminals;
a display for displaying images relating to the racing game, disposed at a position visually recognizable by each of users operating the plurality of terminals;
first memory for storing a sound selection table wherein information pieces representing a plurality of pieces of sound data are associated with a total bet amount; and
second memory for storing the total bet amount of a bet made on each of the plurality of terminals;
wherein each of the plurality of terminals comprises:
local memory for storing the plurality of pieces of sound data;
speakers for outputting the sound data; and
a bet operation device for accepting, in the racing game in which a plurality of characters race, a bet operation for the characters;
a sound output operation device for generating an output signal for outputting sound in response to an operation by a player; and
a local controller for outputting the sound data selected from the plurality of pieces of sound data by the center controller from the speakers,
wherein the center controller at least executes steps of:
(A) receiving a bet amount from each of the plurality of terminals;
(B) accumulating the bet amount received from the plurality of terminals and storing a result thereof to the second memory;
(C) selecting an information piece representing a piece of sound data from among the information pieces representing the plurality of pieces of sound data stored in the first memory, based on the total bet amount stored in the second memory; and
(D) transmitting the information piece representing the piece of sound data to the plurality of terminals, so as to output the sound data from the speakers,
and wherein the local controller executes steps of:
(a) selecting a piece of sound data corresponding to the information piece representing the piece of sound data, upon receiving the information representing the piece of sound data; and
(b) outputting the sound data from the speakers in response to the output signal generated by the sound output operation device.

7. The gaming system according to claim 6, wherein the speakers are directional speakers outputting sound in a predetermined direction.
